(19) United States
(12) Patent Application Publication
(10) Pub. No.: US 2025/0116145 A1
(43) Pub. Date: Apr. 10, 2025

(54) DOOR CHECKER ASSEMBLY FOR VEHICLE

(71) Applicant: ILJIN CO., LTD., Gyeongju-si (KR)

(72) Inventors: Heung Tae KIM, Seoul (KR); Jeong Rae LEE, Seoul (KR); Jung Han KIM, Seoul (KR)

(73) Assignee: ILJIN CO., LTD., Gyeongju-si (KR)

(21) Appl. No.: 18/983,119

(22) Filed: Dec. 16, 2024

Related U.S. Application Data
(63) Continuation of application No. PCT/KR2023/008477, filed on Jun. 19, 2023.

(30) Foreign Application Priority Data
Jun. 17, 2022 (KR) 10-2022-0074449

(51) Int. Cl. E05F 5/02

(52) U.S. Cl. CPC E05F 5/025; E05Y 2201/224; E05Y 2600/626; E05Y 2900/531

(57) ABSTRACT

A door checker assembly for a vehicle which is installed between a vehicle body and a door and assists an opening and closing operation of the door is provided. A door checker assembly for a vehicle according to an example embodiment of the present disclosure may include a checker arm; and a door checker through which the checker arm passes and moves. According to an example embodiment of the present disclosure, the checker arm may include one or more operation surfaces, and the door checker may include a pair of torsion bars; a slider provided on one side of each of the torsion bars; and a case which joins and fixes the pair of torsion bars to each other. According to an example embodiment of the present disclosure, an operation surface of the checker arm may be configured to be formed in a lateral surface direction.

### CROSS-REFERENCE TO RELATED APPLICATIONS

This application is a continuation of International Application No. PCT/KR2023/008477 filed on Jun. 19, 2023, which claims priority to Korean Patent Application No. 10-2022-0074449 filed on Jun. 17, 2022, the entire contents of which are herein incorporated by reference.

### TECHNICAL FIELD

The present disclosure relates to a door checker assembly which is installed in a door of a vehicle and assists opening and closing of the door, and more particularly to a door checker assembly configured to form a door checker with torsion bars, sliders and cases formed integrally therewith so that it can be easily produced with a simpler structure.

### BACKGROUND ART

A door checker assembly is installed and used in a door of a vehicle to assist an opening and closing of the door. For example, as shown in FIG. 1, a door checker assembly 30 may be installed between a vehicle body 10 and a door 20 of the vehicle and function to limit a maximum opening angle of the door and maintain the door in an open state at a predetermined angle.

Referring to FIGS. 2 and 3, an example of the door checker assembly 30 which may be installed and used in the door of the vehicle is exemplarily shown. As shown in the drawings, the door checker assembly 30 may be configured to comprise a checker arm 40, one side of which is rotatably installed in the vehicle body, and a door checker 50 which is installed in the door and to which the checker arm 40 is connected, and the door checker assembly 30 may be configured so that the checker arm 40 passes and slides through the door checker 50 so that it assists an opening and closing of the door.

Specifically, the door checker 50 may be configured such that operating members 70 are biased toward the checker arm 40 via elastic members 80 in a housing 60 to pressurize the checker arm 40. In addition, the checker arm 40 may be configured to have a curved portion 42 on a surface thereof facing the operating member 70 so that a pressure applied by the operating member 70 varies as the checker arm 40 slides and moves relative to the door checker 50.

Incidentally, such a door checker 50 may have a matter in which an assembly process takes a lot of time because the door checker 50 is configured to have a plurality of constituent elements such as the operating members 70 and the elastic members 80 in a narrow space within the housing 60 and foreign substances deposited on the operation surface of the checker arm 40 may cause noise during operation or reduce durability because operation surfaces of the checker arm 40 are formed on upper and lower surfaces thereof.

### DISCLOSURE

### Technical Problem

The present disclosure is intended to address the above-described issues of a door checker assembly for a vehicle, and the present disclosure is for the purpose of providing a vehicle door checker which is able to be produced more simply with a simpler structure while providing durability and noise improvement effects.

### Technical Solution

Representative configurations of the present disclosure to achieve the above-described purpose are as follows.

According to an example embodiment of the present disclosure, a door checker assembly for a vehicle which is installed between a vehicle body and a door and assists an opening and closing operation of the door is provided. A door checker assembly for a vehicle according to an example embodiment of the present disclosure may comprise a checker arm; and a door checker through which the checker arm passes and moves. According to an example embodiment of the present disclosure, the checker arm may comprise one or more operation surfaces, and the door checker may comprise a pair of torsion bars; at least one slider provided on one side of the torsion bar; and at least one case which connects and fixes the pair of torsion bars to each other. According to an example embodiment of the present disclosure, an operation surface of the checker arm may be configured to be formed in a lateral surface of the checker arm.

According to an example embodiment of the present disclosure, each of the torsion bars may comprise an operating part; a leg part which extends in an upward or downward direction from the operating part; and a bend part which is bent and extends from the leg part.

According to an example embodiment of the present disclosure, the slider may be provided in an operating part of the torsion bar.

According to an example embodiment of the present disclosure, the slider may have a guide groove having a recessed structure on a surface thereof facing an operation surface of the checker arm.

According to an example embodiment of the present disclosure, the slider may be configured to at least partially surround the operating part of the torsion bar.

According to an example embodiment of the present disclosure, the slider may be formed, through injection-molding, on the operating part of the torsion bar.

According to an example embodiment of the present disclosure, the operating part of the torsion bar may be formed to have a U-shaped structure in which it extends in a direction of an operation axis.

According to an example embodiment of the present disclosure, the operating part of the torsion bar may be configured to comprise an upper extension portion and a lower extension portion which extend in the direction of the operation axis; and a joint portion which joins the upper extension portion, to form a U-shaped structure by the upper extension portion, the lower extension portion, and the joint portion.

According to an example embodiment of the present disclosure, the leg part of the torsion bar may comprise an upper leg part which extends in an upward direction from the upper extension portion of the operating part, and a lower leg part which extends in a downward direction from the lower extension portion of the operating part.

According to an example embodiment of the present disclosure, the bend part of the torsion bar may comprise an upper bend part 316a which is bent and extends from the upper leg part, and a lower bend part 316b which is bent and extends from the lower leg part.

According to an example embodiment of the present disclosure, the case may be configured to at least partially surround the leg part and the bend part of the torsion bar.

According to an example embodiment of the present disclosure, the case may be formed, through injection-molding, on the torsion bar.

According to an example embodiment of the present disclosure, the case may comprise an upper case which at least partially surrounds the upper leg part and the upper bend part, and a lower case which at least partially surrounds the lower leg part and the lower bend part.

According to an example embodiment of the present disclosure, a stopper member which limits a maximum opening state of the door may be provided at one end of the checker arm, and the case may comprise a stopper receiving groove to which the stopper member is inserted.

According to an example embodiment of the present disclosure, the stopper receiving groove may comprise an upper stopper receiving groove provided at a lower end portion of the upper case; and a lower stopper receiving groove provided at an upper end portion of the lower case.

In addition, the door checker assembly according to the present disclosure may further comprise other additional configurations without departing from the technical sprit of the present disclosure.

### Advantageous Effects

A door checker assembly according to an example embodiment of the present disclosure is configured so that a door checker is formed of torsion bars, a sliders and cases formed integrally therewith. Thus, it is possible to simplify a structure of the door checker and perform an assembly process of the door checker assembly more easily and quickly.

In addition, a door checker assembly according to an example embodiment of the present disclosure is configured so that an operation surface is formed on a lateral surface of a check arm. Thus, it is possible to prevent noise generation or durability deterioration caused by foreign substances deposited on an operation surface of the checker arm.

Furthermore, a door checker assembly according to an example embodiment of the present disclosure is configured so that the case and the slider are integrally injection-molded to the torsion bar. Thus, it is possible to perform the production of the door checker more easily and reduce a weight and production costs of the door checker.

### BRIEF DESCRIPTION OF DRAWINGS

FIG. 1 shows an example of a door checker assembly installed in a door of a vehicle.

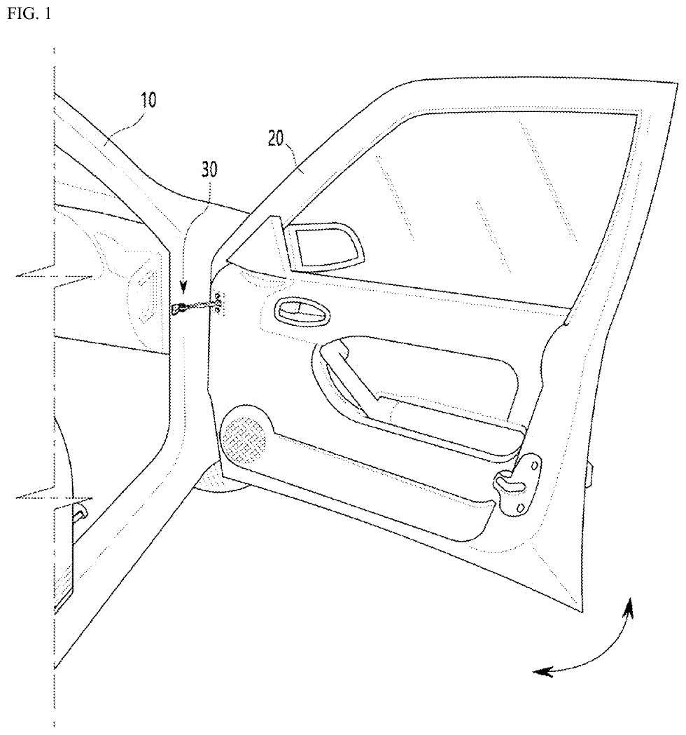

FIG. 2 exemplarily shows the overall structure of the door checker assembly shown in FIG. 1.

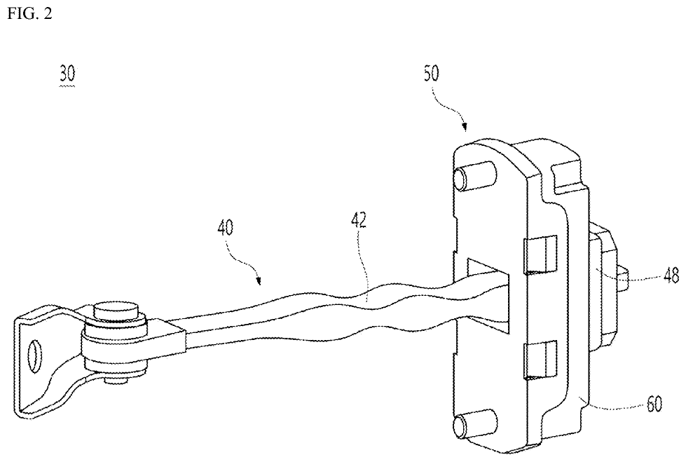

FIG. 3 exemplarily shows an exploded perspective view of the door checker assembly shown in FIG. 2.

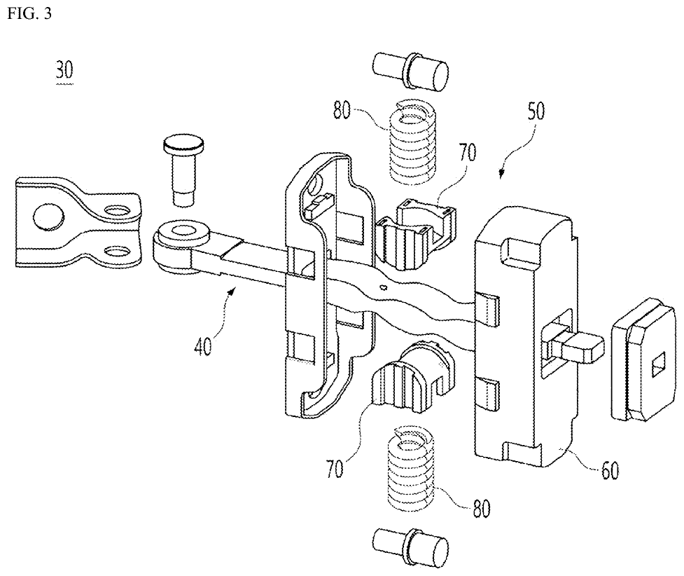

FIG. 4 exemplarily shows a door checker assembly according to an example embodiment of the present disclosure.

FIG. 5 exemplarily shows an exploded perspective view of a door checker assembly according to an example embodiment of the present disclosure.

FIG. 6 exemplarily shows a lateral structure of a door checker assembly according to an example embodiment of the present disclosure.

FIG. 7 exemplarily shows a structure of a door checker which may be used in a door checker assembly according to an example embodiment of the present disclosure.

FIG. 8 exemplarily shows torsion bars of the door checker shown in FIG. 7.

FIGS. 9A and 9B exemplarily show cases of the door checker shown in FIG. 7.

### EXPLANATION OF REFERENCE NUMERALS

100 Door checker assembly
200 Checker arm
210 Hinge hole
220 Hinge
230 Bracket
240 Stopper
250 Operation surface
300 Door checker
310 Torsion bar
312 Operating part (of torsion bar)
314 Leg part (of torsion bar)
316 Bend part (of torsion bar)
320 Slider
322 Guide groove (of slider)
330 Case
332 Stopper receiving groove
334 Fastening bolt

### MODES OF THE INVENTION

Embodiments which will be described below are provided for the purpose of explaining the technical ideas of the present disclosure and the scope of the rights of the present disclosure is not limited to the embodiments which will be presented below or the specific descriptions thereof.

All technical and scientific terms used herein, unless otherwise defined, have the meaning commonly understood by a person of ordinary skill in the art to which the present disclosure belongs and all terms used herein have been selected for the purpose of more clearly describing the present disclosure and have not been selected to limit the scope of the rights of the present disclosure.

The expressions “comprising,” “including,” “having,” and the like, as used herein, needs to be understood as open-ended terms implying the possibility of including other embodiments, unless otherwise stated in the phrase or sentence in which the expression is included.

The singular form described herein may include the plural form unless the context clearly dictates otherwise, and this is equally applied to the singular form set forth in the claims.

Throughout the present specification, when a constituent element is referred to as being “positioned” or “formed” at one side of another constituent element, the constituent element may be in direct contact with the one side of another constituent element, or may be positioned or formed at another constituent element by intervening yet another constituent element therebetween.

Hereinafter, example embodiments of the present disclosure will be described in detail with reference to the accompanying drawings at such an extent that they may be readily practiced by those ordinary skilled in the art. In the accompanying drawings, the same reference numerals are assigned to the same or corresponding constituent elements. Further, in the following descriptions of the embodiments, duplicate descriptions of the same or corresponding constituent elements may be omitted. However, even though descriptions of a specific constituent element are omitted, such a constituent element is not intended to be excluded in a respective example embodiment.

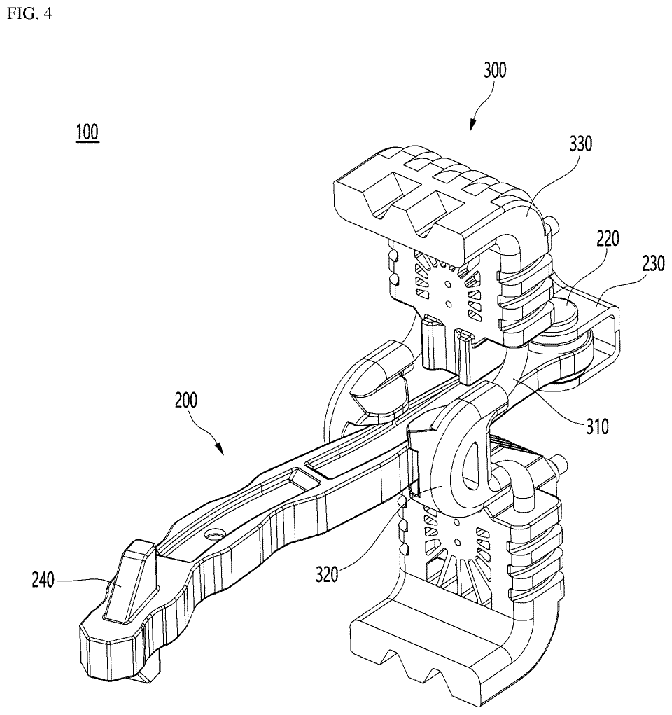

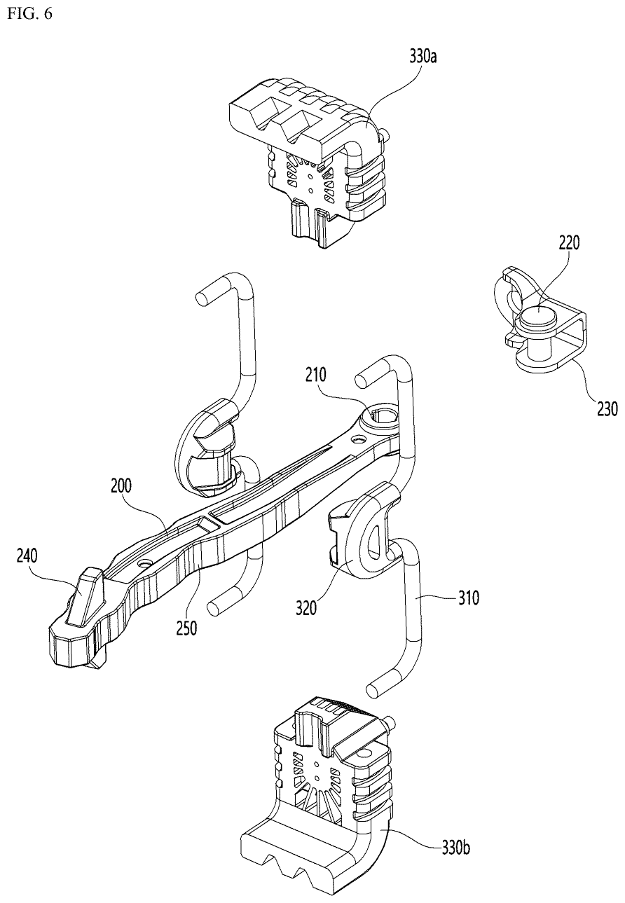

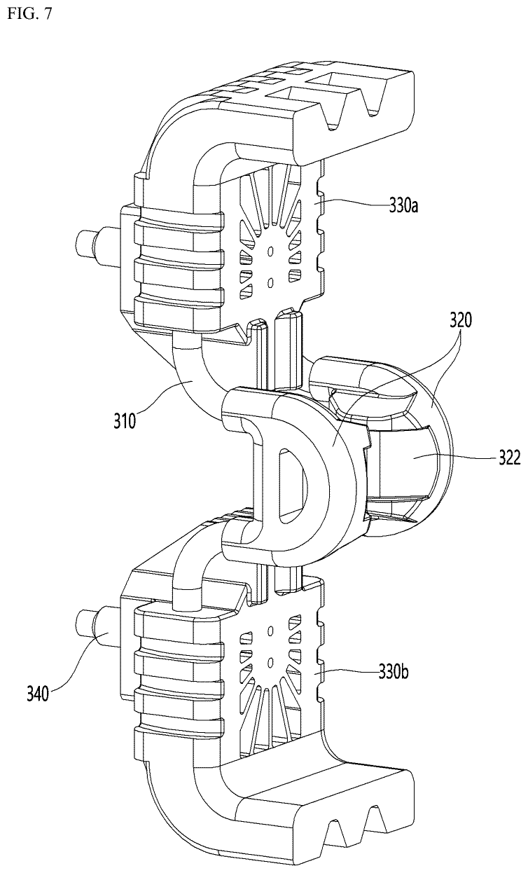

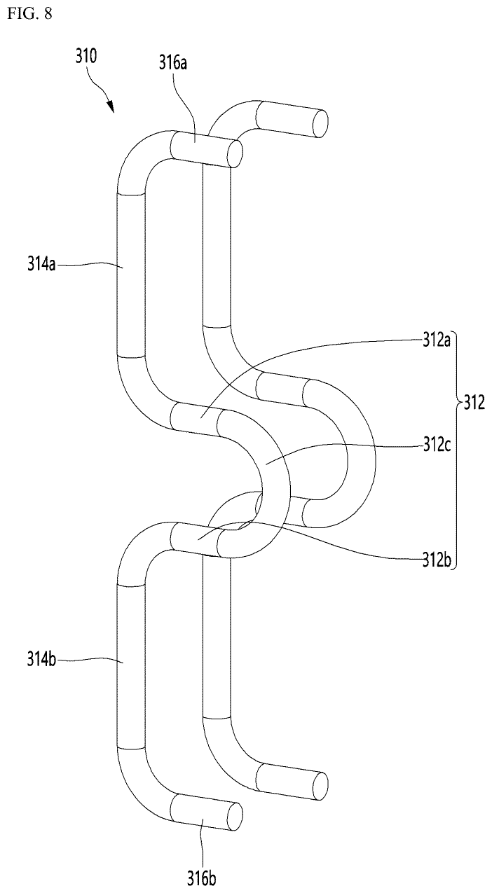

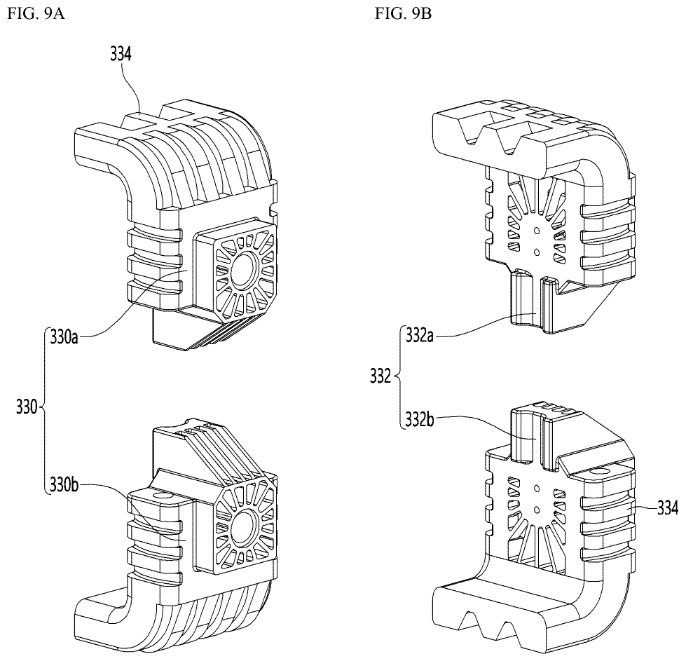

Referring to FIGS. 4 to 9, a door checker assembly 100 according to an example embodiment of the present disclosure is exemplarily shown. As shown in the drawings, the door checker assembly 100 according to an example embodiment of the present disclosure may be configured such that a checker arm slide and move through a door checker to assist an opening and closing of the door, as in a door checker assembly for a vehicle in the related art. In addition, as will be described below, the door checker according to an example embodiment of the present disclosure is characterized by having a structure in which sliders and cases are injection-molded to torsion bars.

According to an example embodiment of the present disclosure, the door checker assembly 100 may be configured to comprise a checker arm 200 formed as a substantially bar shape and rotatably installed in one side of the vehicle body or the door and a door checker 300 installed in the other side of the vehicle body or the door such that the checker arm 200 passes therethrough.

According to an example embodiment of the present disclosure, the checker arm 200 may be configured to be formed by extending in a straight or a curved shape in one direction and may be configured to be rotatably installed in the vehicle body or the door of the vehicle by attaching a bracket to one end thereof.

For example, as shown in the drawing, the checker arm 200 may be configured so that a hinge 220 is inserted into a hinge hole 210 formed at one end thereof and is rotatably connected to a bracket 230 through this and such a bracket 230 may be configured to be fixed to the vehicle body or the like of the vehicle.

According to an example embodiment of the present disclosure, the checker arm 200 may be configured to be connected through the door checker 300 which will be described below, and the other end of the checker arm 200 may comprise a stopper member 240 configured to prevent separation between the checker arm 200 and the door checker 300 and to limit a maximum opening state of the door.

According to an example embodiment of the present disclosure, the checker arm 200 may be configured to have a generally polygonal cross-sectional structure at the time of cutting along a plane perpendicular to the extension direction of the checker arm 200 (for example, the longitudinal direction of the checker arm 200). For example, in an example embodiment shown in the drawing, the checker arm 200 is formed to have a cross-sectional structure of approximately rectangular shape.

According to an example embodiment of the present disclosure, the checker arm 200 may be configured to have operation surfaces 250 which interact with the door checker 300 which will be described below to implement an opening and closing operation of the door.

According to an example embodiment of the present disclosure, the operation surfaces 250 of the checker arm 200 may be configured to be formed on a pair of mutually opposing surfaces. For example, in the case of an example embodiment shown in the drawing, the operation surfaces 250 are formed on both side surfaces of the checker arm 200.

In this way, the door checker assembly 100 according to an example embodiment of the present disclosure is configured so that the operation surfaces 250 of the checker arm 200 are formed on the lateral surfaces instead of the upper and lower surfaces. Thus, it is possible to prevent foreign substances from being deposited on the operation surface 250, thereby preventing noise from occurring during the operation of the door checker assembly or deteriorating the durability of the door checker assembly.

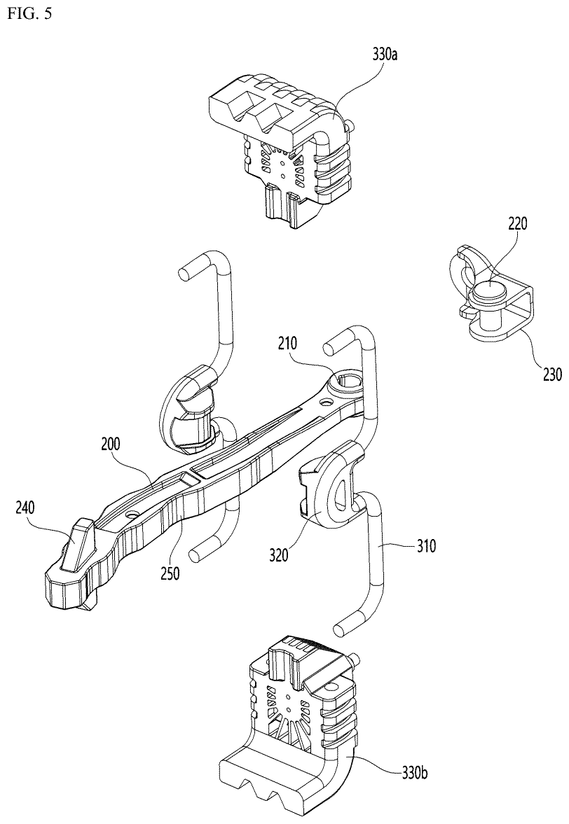

According to an example embodiment of the present disclosure the operating surface 250 of the checker arm 200 may be configured to have one or more concave portions. For example, the operation surface 250 may be configured to have one or more concave portions to form a curved surface, as shown in FIGS. 4 and 5.

In addition, according to an example embodiment of the present disclosure, the door checker 300 may be fixed to the vehicle body or the door and interact with the checker arm 200 described above to perform a function of assisting an opening and closing operation of the door.

According to an example embodiment of the present disclosure, the door checker 300 may be configured to comprise a pair of torsion bars 310 which provide elasticity; one or more sliders 320 which are provided on one side of the torsion bars 310 and in contact with the operation surface 250 of the checker arm 200; and one or more cases 330 which interconnect and fixe the pair of torsion bars 310.

According to an example embodiment of the present disclosure, the torsion bar 310 may be formed to have a bar shape extending approximately in an upward/downward direction and may comprise an operating part 312 which applies pressure to the checker arm 200 via the slider 320; and a leg part 314 which extends in the upward or downward direction from the operating part 312; and a bend part 316 which is bend and extends from the leg part 314.

According to an example embodiment of the present disclosure, the operating part 312 of the torsion bars 310 may be formed to have an approximately U-shaped structure in which it extends in a direction of an operation axis (a direction of movement of the checker arm) and may perform a function of applying elasticity toward the checker arm 200 and pressurizing the checker arm 200 through the slider 320.

According to an example embodiment of the present disclosure, the operating part 312 of the torsion bars 310 may comprise an upper extension portion 312a and a lower extension portion 312b which extend in the direction of the operation axis; and a joint portion 312c which joins the upper extension portion 312a and the lower extension portion 312b. The operating part 312 of the torsion bars 310 may be configured to be formed to have a U-shaped structure in which it is formed of the upper extension portion 312a, the lower extension portion 312b, and the joint portion 312c.

In this way, the door checker assembly 100 according to an example embodiment of the present disclosure forms the operating part 312 of the torsion bars 310 which applies elastic pressure to have a U-shaped structure in which it extends in a direction of an operation axis (direction of movement of the checker arm). Thus, even when the door checker assembly 100 is formed with a structure in which it pressurizes the checker arm 200 using the torsion bars 310 so that sufficient durability may be secured.

According to an example embodiment of the present disclosure, the leg part 314 of the torsion bars 310 is configured to extend in the upward or downward direction from the operating part 312 and may be configured to comprise an upper leg part 314a which extends in an upward direction from an upper end portion of the operating part 312 and a lower leg part 314b which extends in a downward direction from a lower end portion of the operating part 312.

According to an example embodiment of the present disclosure, the bend part 316 of the torsion bars 310 may be formed to have a structure in which it is bent from an end portion of the leg part 314 and enhance the connection force between the torsion bars 310 and the case 330. In addition, the bend part 316 of the torsion bars 310 may be configured to comprise an upper bend part 316a which extends by being bent from an upper end portion of the upper leg part 314a and a lower bend part 316b extending by being bent from a lower end portion of the lower leg part 314b.

According to an example embodiment of the present disclosure, the slider 320 may be provided on the operating part 312 of the torsion bars 310 and configured to receive a torsion load from the torsion bars 310 to pressurize the checker arm 200.

According to an example embodiment of the present disclosure, the slider 320 may be configured to be provided on each of the pair of torsion bars 310, configured to be integrally formed through injection-molding to the operating part 312 of the torsion bars 310, and configured to at least partially surround the operating part 312 of the torsion bars 310.

In this way, the door checker assembly 100 according to an example embodiment of the present disclosure is configured so that the slider 320 of the door checker 300 is integrally formed with the torsion bar 310 through injection-molding. Thus, compared to the door checker assembly in the related art in which springs and sliders are inserted and assembled in the housing, it is possible to simplify the assembly process.

According to an example embodiment of the present disclosure, the slider 320 may be configured to have a guide groove 322 having a recessed structure on a surface facing the operation surface 250 of the checker arm 200, thereby guiding movement of the checker arm 200 through the guide groove 322.

According to an example embodiment of the present disclosure, the case 330 is provided between the pair of torsion bars 310 and may perform a function of fixing and supporting the pair of torsion bars 310.

According to an example embodiment of the present disclosure, the case 330 may be configured to at least partially surround the leg part 314 and the bend part 316 of the torsion bars 310 and configured to securely support the pair of torsion bars 310.

According to an example embodiment of the present disclosure, the case 330 may be configured to comprise an upper case 330a which at least partially surrounds the upper leg part 314a and the upper bend part 316a of the torsion bars 310 and a lower case 330b which at least partially surrounds a lower leg part 314a and the lower bend part 316b of the torsion bars 310.

According to an example embodiment of the present disclosure, the case 330 may be configured to be integrally formed to the torsion bars 310 through injection-molding in a state that the pair of torsion bars 310 are fixed to a mold.

According to an example embodiment of the present disclosure, the upper case 330a and the lower case 330b may be configured to be formed simultaneously through injection-molding or configured to be formed through separate processes.

Also, the case 330 may be configured to be injection-molded to the torsion bars 310 simultaneously with the slider 320 or configured to be formed in another injection-molding process separate from the slider 320.

According to an example embodiment of the present disclosure, the case 330 may comprise a stopper receiving groove 332 on one side thereof. For example, the upper case 330a may comprise an upper stopper receiving groove 332a which extends in a downward direction and the lower case 330b may comprise a lower stopper receiving groove 332b which extends in an upward direction, so that the stopper member 240 provided to the checker arm 200 may restrict movement of the checker arm 200 by being inserted into and brought into contact with the stopper receiving groove 332.

According to an example embodiment of the present disclosure, the case 330 of the door checker 300 may comprise at least one fastening bolt 340 so that the door checker 300 may be configured to be installed in the vehicle via the fastening bolt 340.

According to an example embodiment of the present disclosure, the fastening bolt 340 may be configured to be integrally coupled to the case 330 of the door checker 300. For example, the fastening bolt 340 may be configured to be integrally coupled to the case 330 by performing injection-molding of the case 330 while inserting the pair of torsion bars 310 and the fastening bolt 340 together into a mold at the time of forming the case 330 through injection-molding.

According to an example embodiment of the present disclosure, the fastening bolt 340 may be configured to be provided in each of the upper case 330a and the lower case 330b at least once.

According to an example embodiment of the present disclosure, the case 330 may be formed to have a shape in which it extends along the leg part 314 and the bend part 316 of the torsion bar 310. In addition, if necessary, one or more rib parts 334 may be provided to enhance the mechanical rigidity of the case 330 formed through plastic injection-molding.

As described above, the door checker assembly according to an example embodiment of the present disclosure is configured such that the door checker is formed of the torsion bars, and the slider and case formed integrally therewith, thereby simplifying the structure of the door checker and making the assembly process of the door checker assembly easier and faster.

In addition, the door checker assembly according to an example embodiment of the present disclosure is configured so that the operation surface is formed on the lateral surface of the checker arm, thereby preventing noise generation or durability degradation caused by foreign substances deposited on the operation surface of the checker arm.

Furthermore, the door checker assembly according to an example embodiment of the present disclosure is configured so that the case and the slider are integrally injection-molded with the torsion bar, thereby facilitating the production of the door checker and reducing the weight and the production costs of the door checker.

Although the present disclosure has been described above in terms of specific items such as detailed constituent elements as well as the limited example embodiments, they are merely provided to help more general understanding of the present disclosure, and the present disclosure is not limited to the above example embodiments. Various modifications and changes could have been realized by those skilled in the art to which the present disclosure pertains from the above description.

Therefore, the spirit of the present disclosure need not to be limited to the above-described example embodiments, and in addition to the appended claims to be described below, and all ranges equivalent to or changed from these claims need to be said to belong to the scope and spirit of the present disclosure.

What is claimed is:

1. A door checker assembly for a vehicle which is installed between a vehicle body and a door and assists an opening and closing operation of the door, the door checker assembly for a vehicle comprising:
a checker arm (200); and
a door checker (300) through which the checker arm (200) passes and moves,
wherein the checker arm (200) comprises one or more operation surfaces (250) and
the door checker (300) comprises a pair of torsion bars (310); at least one slider (320) provided on one side of the torsion bars (310); and at least one case (330) which connects and fixes the pair of torsion bars (310) to each other, and
the operation surface (250) of the checker arm (200) is configured to be formed in a lateral surface of the checker arm (200).

2. The door checker assembly for a vehicle of claim 1, wherein each of the torsion bars (310) comprises:
an operating part (312);
a leg part (314) which extends in an upward or downward direction from the operating part (312); and
a bend part (316) which is bent and extends from the leg part (314).

3. The door checker assembly for a vehicle of claim 2, wherein the slider (320) is provided in an operating part (312) of the torsion bar (310).

4. The door checker assembly for a vehicle of claim 3, wherein the slider (320) has a guide groove (322) having a recessed structure on a surface thereof facing the operation surface (250) of the checker arm (200).

5. The door checker assembly for a vehicle of claim 3, wherein the slider (320) is configured to at least partially surround the operating part (312) of the torsion bar (310).

6. The door checker assembly for a vehicle of claim 5, wherein the slider (320) is formed, through injection-molding, on the operating part (312) of the torsion bar (310).

7. The door checker assembly for a vehicle of claim 6, wherein the operating part (312) of the torsion bar (310) is formed to have a U-shaped structure in which it extends in a direction of an operation axis.

8. The door checker assembly for a vehicle of claim 7, wherein the operating part (312) of the torsion bar (310) is configured to comprise an upper extension portion (312a) and a lower extension portion (312b) which extend in the direction of the operation axis; and a joint portion (312c) which joins the upper extension portion (312a), to form a U-shaped structure by upper extension portion (312a), the lower extension portion (312b) and the joint portion (312c).

9. The door checker assembly for a vehicle of claim 8, wherein the leg part (314) of the torsion bar (310) comprises
an upper leg part (314a) which extends in an upward direction from the upper extension portion (312a) of the operating part (312), and
a lower leg part (314a) which extends in a downward direction from the lower extension portion (312b) of the operating part (312).

10. The door checker assembly for a vehicle of claim 9, wherein the bend part (316) of the torsion bar (310) comprises
an upper bend part (316a) which is bent and extends from the upper leg part (314a), and
a lower bend part (316b) which is bent and extends from the lower leg part (314b).

11. The door checker assembly for a vehicle of claim 10, wherein the case (330) is configured to at least partially surround the leg part (314) and the bend part (316) of the torsion bar (310).

12. The door checker assembly for a vehicle of claim 11, wherein the case (300) is formed, through injection-molding, on the torsion bar (310).

13. The door checker assembly for a vehicle of claim 12, wherein the case (330) comprises:
an upper case (330a) which at least partially surrounds the upper leg part (314a) and the upper bend part (316a), and
a lower case (330b) which at least partially surrounds the lower leg part (314b) and the lower bend part (316b).

14. The door checker assembly for a vehicle of claim 13, wherein a stopper member (240) which limits a maximum opening state of the door is provided at one end of the checker arm (200), and
the case (330) comprise a stopper receiving groove (332) to which the stopper member (240) is inserted.

15. The door checker assembly for a vehicle of claim 14, wherein the stopper receiving groove (332) comprises an upper stopper receiving groove (332a) provided at a lower end portion of the upper case (330a); and a lower stopper receiving groove (332b) provided at an upper end portion of the lower case (330b).
